(19) United States
(12) Patent Application Publication
(10) Pub. No.: US 2018/0352750 A1
(43) Pub. Date: Dec. 13, 2018

(54) METHOD FOR PROPAGATION OF POPLAR TREE FROM LEAF CUTTINGS

(71) Applicant: BIOTECNOLÓGICA EMPRESARIAL DEL SUR SPA, Talca (CL)

(72) Inventors: Rolando GARCÍA, Talca (CL); Gabriela VIZCARRA, Talca (CL)

(73) Assignee: BIOTECNOLÓGICA EMPRESARIAL DEL SUR SPA, Talca (CL)

(21) Appl. No.: 15/778,384

(22) PCT Filed: Nov. 22, 2016
(86) PCT No.: PCT/IB2016/057040

§ 371 Date: May 23, 2018

(30) Foreign Application Priority Data
Nov. 23, 2015 (CL) 03438-2015

(51) Int. Cl. A01G 2/10; A01G 9/24

(52) U.S. Cl. CPC A01G 2/10; A01G 24/13; A01G 9/24

(57) ABSTRACT

The presently claimed invention is related to a method for vegetative propagation of poplar trees (Populus sp.), from prepared leaf cuttings, wherein the method comprises the steps of: a) providing cuts of leaf cuttings from a donor tree, b) immersing the prepared leaf cutting into a combination of growth regulators, c) planting the prepared leaf cutting into a solid substrate of organic and/or inorganic origin, d) inducing sprouting and rooting of the prepared leaf cutting, by means of controlled ambient temperature, humidity and illumination, wherein steps a) through d) always occur outside an in vitro environment; and embodiments thereof.

### FIELD OF THE INVENTION

The presently claimed invention is related to a new technology for vegetative propagation of poplar trees (Populus sp.), wherein it has been preferably found that this technology is useful in forestry, using leaf cuttings prepared to such purpose.

### AIM OF THE INVENTION

The present application refers to a novel method for in vivo propagation of poplar trees (Populus sp.) from leaf cuttings and under greenhouse conditions. The method is based on the handling of plant growth regulators (PGR), the environmental growth conditions of the plant, as well as the selection and preparation of the cuttings, allowing reaching the totipotent expression of the plant cell and obtaining plants, according to the invention. Even though leaves are abundant in trees and woody shrubs, they are not generally used as plant propagation material, since the more frequent methods for asexual propagation use buds, cuttings, grafts, roots and mini-cuttings as plant material.

The state of the art does not provide massive protocols for commercial use of in vivo propagation, allowing propagating woody species, and using leaf cuttings as a method. Moreover, the use of leaves has been limited in the past to propagate herbaceous plants, especially for ornamental use, and to propagate plants under specific conditions, using in vitro technologies.

There is a need to develop new propagation technologies that allow the successful in vivo propagation of poplar trees from leaves. The methodology proposed is the presently claimed invention based on the use of leaf cuttings is a plausible solution to meet this need.

### INTRODUCTION

In terms of plant propagation, turning to sexual reproduction may be counterproductive, especially when the aim is to ensure the permanence of specific features of interest present in some individuals of a population. Thus, the use of seeds is no longer a viable alternative, and it is accessary to implement plant or asexual (clonal) propagation or reproduction methodologies. The main techniques used to date are: propagation by cuttings or other propagules, and in vitro culture (with the different variants); each having advantages and disadvantages depending on the aim to be achieved.

In the particular case of in vitro culture, this technique is conventionally used when the classic in vivo propagation methods are insufficient for the productive needs (slow response, limitation given by the amount of plant material available for propagation); however, the technology required for such purposes is relatively complex, and its costs are high. Therefore, this technique is less required and reserved only for particular cases.

In the current production scenario, and with increasing frequency, in the forestry field the clonal culture has been selected for use, thereby establishing monoclonal plantations in order to obtain homogeneity in yields and in the productive practices which must be carried out during the establishment and development of plantations.

Developing clonal plantations requires a good availability of reproductive material; hence, asexual propagation is applied by different techniques. Propagation by cuttings is one of the most widely extended methods; however, it may have technological barriers preventing it from being widespread, due to either the poor availability of the propagation material or the physiological response of the species.

In the case of establishing clonal plantation for different purposes, plant propagation is a reality applied to forest species of great importance, such as poplar trees. Nevertheless, in some species this forestry practice can be limited due to the difficulty of commercial propagation through clonal techniques. For instance, some relevant genotypes of poplar trees have very low rooting and sprouting rates. In an embodiment, the presently claimed invention shows successful methodologies for in vivo propagation of poplar leaf cuttings.

The method proposed by the presently claimed invention is supported by the toripotentiality of plant cells. This invention demonstrates the feasibility of developing full poplar plants based on the culture of leaves and leaf segments, prepared as cuttings, treated with growth regulators, and maintained under controlled conditions of temperature, moisture and substrates in greenhouse conditions.

Moreover, the presently claimed invention has diverse advantages over the aforementioned plant propagation methodologies: it is easy to develop, being a very massive method, genetically stable and having a very relevant quality when applied to deciduous species, namely it allows producing material the whole year. Another advantage is that it has very good rates of rooting, sprouting and survival, even higher than the conventional in vitro and in vivo techniques for some woody species. Furthermore, its implementation is quick and low-cost.

### BACKGROUND OF THE INVENTION

### State of the Art

Document WO 02/03776 relates to a method for vegetative propagation of poplar trees from root cuttings using a suitable growth medium (multi-nutrient fertilizers). This document does not disclose leaf propagation as a means of propagation.

The document entitled: “Vegetative Tree Propagation in Agroforestry, Training Guidelines and References” refers to different technologies fox propagating trees. Different chapters provide technical recommendations for propagating and maintaining trees during propagation. The book is relevant, since if focuses on the more common propagation practices for woody species. In the practice, this book is considered as a FAO's Practical Guide. Although the book describes very well the different types of cuttings used in the industry, it does not mention or address the use of leaf cuttings in the commercial production of seedlings.

The document entitled “Cutting Propagation Methods for PNW Native Shrubs and Trees” emphasizes that the ability of plants to grow from any tissue segment is related to their ability to heal and interact with different environmental conditions. It further states that the natural balance of plant hormones can affect the ability of tissues to survive and form a new plant. Similarly, it is indicated that callus production in wounded areas is critical and that the same hormones related to callus formation are directly related to rooting.

The document entitled “Basic techniques for propagating plants” explains some techniques for the vegetative propagation of plants. It points out that plants propagated by these methods have the same characteristics as donor plants, since vegetative material is used and genetic recombination is not involved. The authors state that leaf cuttings are used in some plant species with specific characteristics, but they do not refer to woody plants.

The book “Plant Propagation: Principles and Practices”, edited by Hartmann et al., discloses the basic principles that support the use of leaf cuttings with or without buds. This document is very important because it states in different parts that it is very difficult to propagate from this plant material. However, it is also indicated that this type of cutting is very important when there is not enough propagation material available. It is also interesting that in this document this type of plant material is never recommended for propagating woody species.

### SUMMARY OF THE INVENTION

The presently claimed invention addresses the development of a new technology for the in vivo propagation of poplar trees (Populus sp.).

In one embodiment of the invention, a propagation methodology is presented for multiplying poplar trees. The choice of poplar trees as a representative species of woody trees was based on being an excellent model species, as it grows faster than other woody species and is a highly prized species from the commercial point of view in the world timber industry.

In the presently claimed invention leaf tissues from shoots developed during the growing season (spring and summer) were collected from donor poplar trees. The tissues were collected and stored in a humid chamber to be transported to the nursery. Once in the greenhouse, the expanded leaves were cut from the shoot, maintaining the petiole, and were inoculated for 30 minutes in an aqueous solution containing different concentrations of plant growth regulators (PGRs).

After being treated with growth regulators, the leaves were planted in a warm bed for 60 days to induce sprouting and rooting. The substrate temperature was adjusted to 24° C. for all treatments and irrigation was performed with a MIST system, maintaining greenhouse humidity above 85%. The efficiency of the propagation system was evaluated, as well as propagation with naked root and covered root in containers of 100 cc.

For all species the production of plants was evaluated in different types of organic and inorganic substrates: pine sawdust, sand, peat, perlite, vermiculite. In parallel, the use of a hydroponic system for propagating from the mentioned leaf cuttings was evaluated.

On average, callus formation was observed two or three weeks after planting the leaf cuttings into warm beds in almost all treatments. Meanwhile, root formation took place between the fourth and fifth weeks of cultivation. The regeneration of the whole plant was visible between 45 and 60 days alter planting, depending on the plant species or genotype.

Plant propagation was possible in all substrates evaluated, although it may vary from one substrate to another, depending on the species and the genotype. In the case of poplar trees, each leaf was capable of forming between 1 and 4 new shoots or plants (see FIG. 6).

The propagation of plants by technology based on leaf cuttings was possible both on bare root and in containers. It is the first time that leaf cuttings show levels of efficiency that allow their use on a commercial scale. It is claimed that according to our technical data, it is the first time that poplar leaf cuttings have been an inventive method of propagation with respect to traditional hardwood cuttings, grafts, seeds and other forms of propagation.

### BRIEF DESCRIPTION OF THE DRAWINGS

FIG. 1. Schematic representation diagram of the different types of cuts made to the leaves for the preparation of the cuttings. A-D) Leaf cuttings without buds. The leaf presented in the drawing is generic and does not correspond to a particular species.

FIG. 2. Survival of Populus sp. leaf cuttings subjected to different hormonal treatments in warm bed.

FIG. 3. Effect of the treatment with growth regulators (according to Table 1) on cuttings of whole leaves of Populus sp. To the left, treatments for the hybrid Populus trichocarpa x deltoide x Populus deltoide; to the right, treatments for the hybrid Populus trichocarpa x Populus trichocarpa. A: 2-iP+IBA TDxD, B: 6-BAP+IBA TDxD; C: 2-iP+IBA TxT; D: 6-BAP+IBA TxT. Percentage (%) of sprouting represented by light colored bars and % of rooting represented by dark colored bars.

FIG. 4. Formation of whole plants of Populus sp., in sand substrate, at 60 days of planting the leaf cutting.

FIG. 5. Formation of roots of Populus sp., from two types of leaf cuttings at 14 days of planting.

FIG. 6. Formation of multi-greens of Populus sp., from two types of leaf cuttings at 35 days of planting.

FIG. 7. Growth and development of poplar plants grown from leaf cuttings. A) Plants in shade grown to be transplanted; B) Plants grown in 0.5 kg hags to foe transplanted; C) Formation and development of multi-greens in the shade from cuttings grown in bags; D) Poplar plants generated from leaf cuttings, one year later.

### DETAILED DESCRIPTION OF THE INVENTION

In the presently claimed invention it will be understood that the steps of the defined culture conditions which always occur outside an in vitro environment are represented by a crop under greenhouse conditions, a crop under hydroponic conditions, or an outdoor crop.

### Selection of Plant Material

1. The present technology is useful for propagating adult trees, hedges, shrubs, small mother plants and nursery plants.

2. For any of the evaluated species, the selection of the donor branches is carried out considering phenological age, favoring branches of the season, with little lignification. However, adult branches can be used as donors, if necessary and depending on the species under study.

3. The cuttings prepared from petiolated or welded leaves.

4. The cuttings are cut and kept in a chilled and humid chamber, where they are transported to their destination.

### Preparation of the Cutting

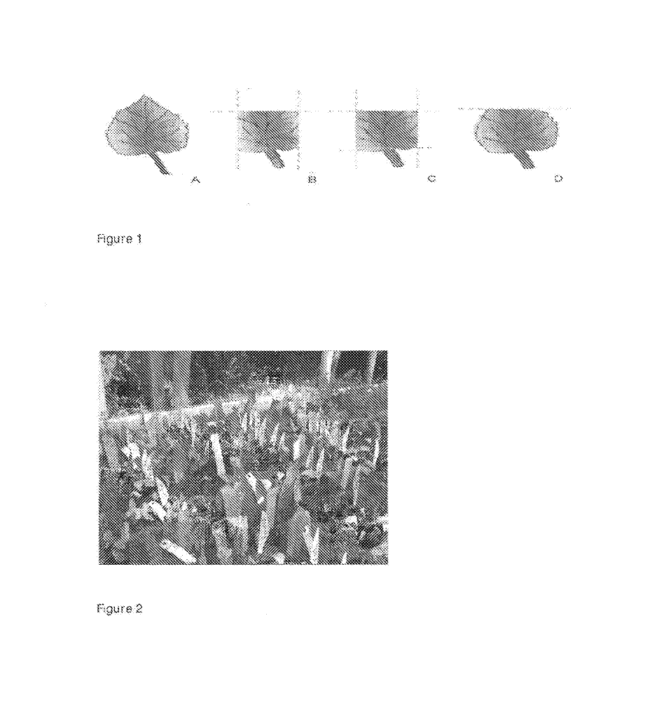

5. The preparation of the cutting may depend on the species, type of leaf, phenological age of the branch and the leaves. The cuttings can be prepared as shown in FIG. 1.

6. The cuttings of leaves without buds are prepared maintaining the length of the petiole between 3 and 10 cm, depending on the species. Usually, these are petiolated cuttings.

7. Once prepared, the cuttings are immersed into an aqueous solution with growth regulators containing auxins (IBA) or cytokinins (BAP, 2-iP, indistinctly) or the mixture of auxins and cytokines (IBA+BAP or IBA+2-iP) in a concentration range of 0 mgL⁻¹ to 10 mgL⁻¹ of each growth regulator, either simply added or mixed. For example, the concentration of the regulator may be selected from 1, 1.5, 2, 2.5, 3, 3.5, 4, 4.5, 5, 5.5, 6, 6.5, 7, 7.5, 8, 8.5, 9, 9.5 or 10 mgL⁻¹.

8. Immersion in the aqueous solution occurs for 5 to 60 minutes, depending on the type of cutting, species and phenological age of the donor tree. For example, the immersion time may be 5, 6, 7, 8, 9, 10, 15, 20, 25, 30, 35, 40, 50 or 60 minutes.

9. Alternatively, the cuttings may be smeared with talc enriched with growth regulators containing auxins (IBA) or cytokinin (BAP, 2-iP, indistinctly) or the mixture of auxins and cytokinins (IBA+BAP or IBA+2-iP) in a concentration range of 0 mgg⁻¹ to 10 mgg⁻¹ of each growth regulator, whether simply added or mixed.

### Induction of Shoots and Roots

10. The cuttings either treated with aqueous solution of regulators or smeared with enriched talcum are planted in solid substrates of organic or inorganic origin (e.g., compost, humus, guano, leaf soil, peat, sand, sawdust, coconut fiber, perlite, vermiculite, and zeolite) applied independently or in mixtures of one or more substrates at different ratios.

11. Alternatively, the cuttings can be planted in liquid substrates such as water, hydroponics solutions, nutrient solutions, culture media or simple mixtures of organic carbon sources.

12. Plastic, poly-foam, nylon, polystyrene, metal, mud, wood or any other synthetic or organic material (cellulose fiber, for example) are used for planting into solid substrates to serve as a container. Any measure of container can be used, depending on the species and the type of cutting.

13. Alternatively, a bed with any of the above-mentioned substrates can be used enabling planting the cutting directly into the substrate and generation of a bare root plant.

14. Plastic, glass, coated wood, metal, polystyrene, poly-foam, ceramic and other organic or inorganic materials can be used for planting into liquid substrates to be used as culture containers. The dimensions of the container for liquid substrate culture may be variable, depending on the species, type of cutting, phenological age of the cutting or age of the selected trees.

15. Culturing cuttings to induce sprouting and roofing is carried out indistinctly under greenhouse conditions, with controlled ambient temperature and illumination. The parameters temperature and brightness can vary in minimum and maximum ranges from 0 to 50° C. for the first one and 0 to 500 molm²s⁻¹ for the second one.

16. The temperature of the substrate can be controlled with warm bed operated with electricity, steam, hot water, hot air, radiant floor or any system that allows handling the temperature suitable for the species under study. The minimum and maximum temperature ranges for the substrate recorded are 4 to 40° C.

17. The environmental humidity is regulated by irrigation that guarantees an environmental humidity in a range of 60-100% of ambient humidity at the height of the leaf and field capacity of the substrate. To irrigate it is recommended any irrigation system available that delivers small particles of water, in the form of mist, micro-drops, or micro-lamellas.

One embodiment of the presently claimed invention relates to the propagation of poplar species, particularly the Populus trichocarpa x Populus trichocarpa (T x T) and Populus trichocarpa x deltoides x Populus deltoides (TD x D) hybrids. Plant hedges maintained under field conditions were used as donors of leaf cuttings. Leaves of the season, juvenile, well developed, expanded and without signs of maturity were used. Two types of leaves were evaluated: leaves welded to the stem and non-welded leaves. Likewise, the effect of leaf preparation was evaluated, considering them as whole leaves subjected to cuts of their lateral, abaxial and apical ends. Once prepared, the cuttings were immersed during any of these three times: 10, 20 or 30 minutes, into aqueous-based hormone solutions of growth regulators of the cytokinin type: 2-Isopentenyl adenine (2-iP) and Benzylamino purine (BAP) at 0; 1.5; 2.5; 5 mgL⁻¹; and of the auxin type: indole-butyric acid (IBA) at 0; 2 mgL⁻¹. The effect of individual application of each type of regulator and the combination of cytokinins and auxin was evaluated. After this time each of the cuttings was planted into their respective plant production system. Each growth regulator treatment was evaluated in a plant production system with a substrate comprising sand or sawdust and compost. All the experiments were developed in a polycarbonate greenhouse, with a MISTMATIC irrigation and pivot micro-sprinklers. The survival rate ranged from 75% to 89% in all treatments evaluated.

This is the first time that poplar species are propagated under ex vitro conditions using leaf cuttings as an alternative to traditional propagation methods, under greenhouse conditions.

### Description of the Invention

The presently claimed invention relates to a method for vegetative propagation of poplar trees (Populus sp.), from prepared leaf cuttings, wherein the method comprises the following steps:

a) providing cuts of leaf cuttings from a donor tree,

b) immersing the prepared leaf cutting into a combination of growth regulators,

c) planting the prepared leaf cutting into a solid substrate of organic and/or inorganic origin,

d) inducing sprouting and rooting of the prepared leaf cutting, by means of controlled ambient temperature, humidity and illumination,

wherein steps a) through d) always occur outside an in vitro environment.

In a preferred embodiment, in the method for vegetative propagation of poplar trees (Populus sp.), from prepared leaf cuttings, the method comprises the following steps:

a) providing cuts of leaf cuttings from a donor tree, wherein the cuttings have a petiole of up to 10 cm in length,

b) immersing the prepared leaf cutting into a composition comprising at least one growth regulator, for a time period of less than or equal to 60 minutes, wherein said growth regulator is indole-butyric acid (IBA), or the cytokinins: 6-Benzylaminopurine (BAP, 6-BAP), 2-Isopentenyl adenine (2-iP) or a combination of said auxin and said cytokinins in a concentration equal to or less than 10 mgL⁻¹ of each,

c) planting the prepared leaf cutting in a solid substrate of organic and/or inorganic origin, wherein the substrate is selected from the group consisting of compost, humus, guano, ground leaves, peat, sand, sawdust, coconut fiber, perlite, vermiculite, and zeolite, applied independently or in mixtures of one or more substrates at different ratios,

d) inducing sprouting and rooting of the prepared leaf cutting, by means of controlled ambient temperature, humidity and illumination, wherein the temperature varies in minimum and maximum ranges from 4 to 40° C., ambient humidity of 40-100% at the height of the cutting, and brightness between 0 to 1000 μmolm²s⁻¹,

wherein steps a) through d) always occur outside an in vitro environment.

In another preferred embodiment of the method, the length of the petiole is between 0.5 and 10 cm.

In a further preferred embodiment of the method, the combination of growth regulators is in the form of an aqueous solution or in the form of a powder comprising said regulators adsorbed onto a solid carrier.

In another preferred embodiment, said combination of auxins and cytokinins is selected from the group consisting of IBA+BAP or IBA+2-iP.

In a further preferred embodiment of the method, said growth regulator is in a solution having a concentration of 1.0, 1.5, 2.0, 2.5, 3.0, 3.5, 4.0, 5, 5.0, 5.5, 6.0, 6.5, 7, 7.5, 8, 8.5, 9.5 or 10 mgL⁻¹.

In another preferred embodiment of the method, said growth regulator is in powder form having a concentration of 1, 1.5, 2, 2.5, 3, 3.5, 4, 4.5, 5, 5.5, 6.5, 7.5, 7.5, 8, 8.5, 9, 9.5 or 10 mg/g.

In a further preferred embodiment of the method, the prepared cutting is immersed into the solution with growth regulators for a time period of 5, 6, 7, 8, 9, 10, 15, 20, 25, 30, 35, 40, 50 or 60 minutes.

The presently claimed invention in a further embodiment relates to a method for vegetative propagation of poplar trees (Populus sp.) from prepared leaf cuttings, wherein the method comprises the following steps:

a) providing cuts of leaf cuttings from a donor poplar tree, wherein the cuttings are prepared maintaining a petiole having a length of 3 to 10 cm,

b) immersing the prepared leaf cutting into an aqueous solution containing growth regulators, selected from the group consisting of IBA, BAP, 2-iP, IBA+BAP or IBA+2-iP in a range of concentrations of up to 5 mgL⁻¹ of each growth regulator, either simply added or mixed, wherein immersion into the aqueous solution occurs for 10 minutes,

c) planting the prepared leaf cutting into a solid substrate of organic and/or inorganic origin, wherein the substrate is selected from the group consisting of sand, sawdust, compost, applied independently or in mixtures of one or more substrates at different ratios,

d) inducing sprouting and rooting of the prepared leaf cutting, by means of controlled ambient temperature, humidity and illumination, wherein the temperature varies in minimum and maximum ranges from 21 to 29° C., ambient humidity of 65-85% and maximum brightness is 930 μmolm²s⁻¹.

wherein steps a) through d) always occur outside an in vitro environment.

### EXAMPLES

### Example 1

### Experimental Results for Poplar Trees by Leaf Cuttings

### 1.1. Experimental Conditions

### 1.1.2. Preparation of Cuttings

Leaf cuttings from plant hedges maintained under field conditions were used. Leaves of the season, juvenile, well developed, expanded and without signs of maturity were used. The leaves had a minimum length from the base to the apex of 10 cm. Two types of leaves were evaluated: leaves welded to the stem and non-welded leaves. Likewise, the effect of the preparation of the leaf was evaluated, considering them as whole leaves subjected to cuts of their lateral, abaxial and apical ends, according to FIG. 1.

Leaf cuttings isolated from Populus trichocarpa x Populus trichocarpa (T x T) and Populus trichocarpa x deltoides x Populus deltoides (TD x D) hybrids were used.

### 1.1.3. Hormonal Treatments

Once prepared, the cuttings were immersed into aqueous-based hormone solutions of growth regulators of the cytokinin type: 2-Isopentenyl adenine (2-iP), Benzylamino purine (BAP) at 0; 1.5; 2.5; 5 mgL⁻¹; and of the auxin type: indole-butyric acid (IBA) at 0; 2 mgL⁻¹. The effect of the individual application of each type of regulator and the combination of the cytokinins with the auxin, as shown in Table 1, was evaluated.

TABLE 1
Hormonal treatments evaluated for the propagation
of poplar trees by leaf cuttings.

| | |
|---|---|
| IBA | BAP (mgL⁻¹) |

| (mg L⁻¹) | 0 | 1.5 | 2.5 | 5 |
|---|---|---|---|---|
| 0 | T1 | T2 | T3 | T4 |
| 2 | T5 | T6 | T7 | T8 |

| | |
|---|---|
| IBA | 2-iP (mgL⁻¹) |

| (mg L⁻¹) | 0 | 1.5 | 2.5 | 5 |
|---|---|---|---|---|
| 0 | T1 | T2 | T3 | T4 |
| 2 | T5 | T6 | T7 | T8 |

The cuttings were immersed into each growth regulator solution during any of the following times: 10, 20 or 30 minutes under greenhouse environmental conditions. After this time each of the cuttings was planted into their respective plant production system.

### 1.1.4. Type of Plant Production System and Environmental Conditions

Each of the growth regulator treatments was evaluated in a plant production system with a substrate comprising sand or sawdust and compost. For all treatments, the substrates were sterilized by slow cooking for 6 hours at 160° C.

All the experiments were developed in a polycarbonate greenhouse, with a MISTMATIC irrigation and pivot micro-sprinklers. The greenhouse conditions complied with those established in Example 1.

The cuttings were grown under a bare root production system in a warm bed wherein the average daily substrate temperature of 25.38±4° C. (14420 observations), with a minimum recorded of 17° C. and a maximum recorded of 35° C.

### 1.1.5. Experimental Design and Statistical Analysis

Three replicates of each treatment were performed with 15 leaf cuttings per replicate. The effect of the treatments and the welded leaf cutting on the variables related to propagation efficiency were evaluated: % sprouting, % rooting, % survival; height of the shoots. A single evaluation was performed at 60 days of the experiment. The data were processed with the BioSTATS 3.5 statistical package. To determine if there were any differences between treatments, a Kruskal-Wallis test (p<0.05) was performed.

### 1.2. Results

### 1.2.1. Survival of Leaf Cuttings

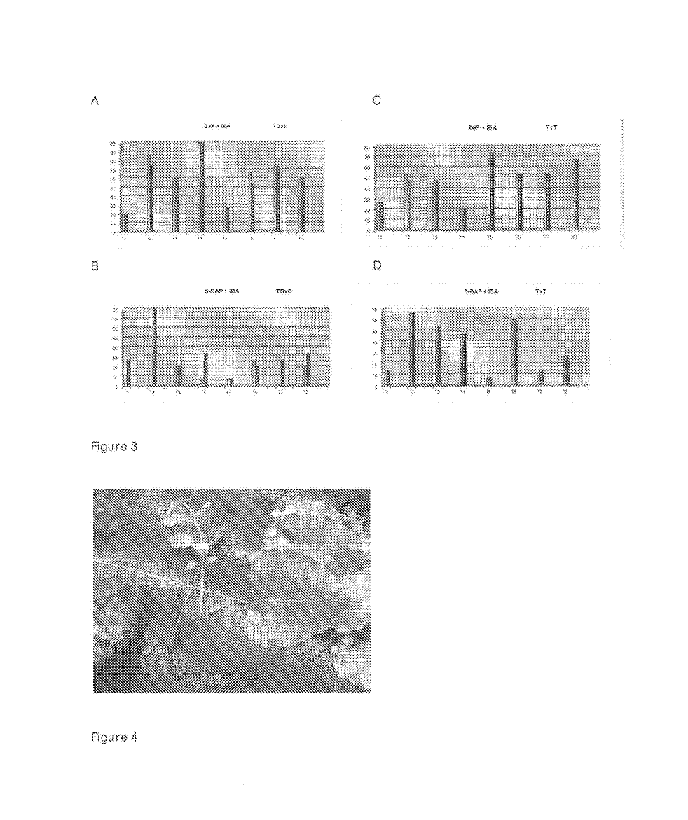

A survival rate ranged from 75% to 89% was obtained in all treatments evaluated. No significant effect of the substrate type or hormone treatment on the survival of the cuttings was observed (FIG. 2).

### 1.2.2. Sprouting and Rooting from Leaf Cuttings

At 60 days, sprouting was obtained in most hormonal treatments with an efficiency that fluctuated between 6.7% and 100% for genotypes TD x D and between 6.7% and 73% for genotypes T x T (see FIG. 3). In general, the shoots emerged from 30 days after the cuttings were grown in the two types of substrates. Nevertheless, these times may vary according to the growth regulator treatment.

Root formation was obtained in most of the evaluated treatments and efficiency fluctuated between 6.7% and 73.3% for both genotypes (FIG. 3). Callus formation and root formation were induced from days 7 and 10, respectively.

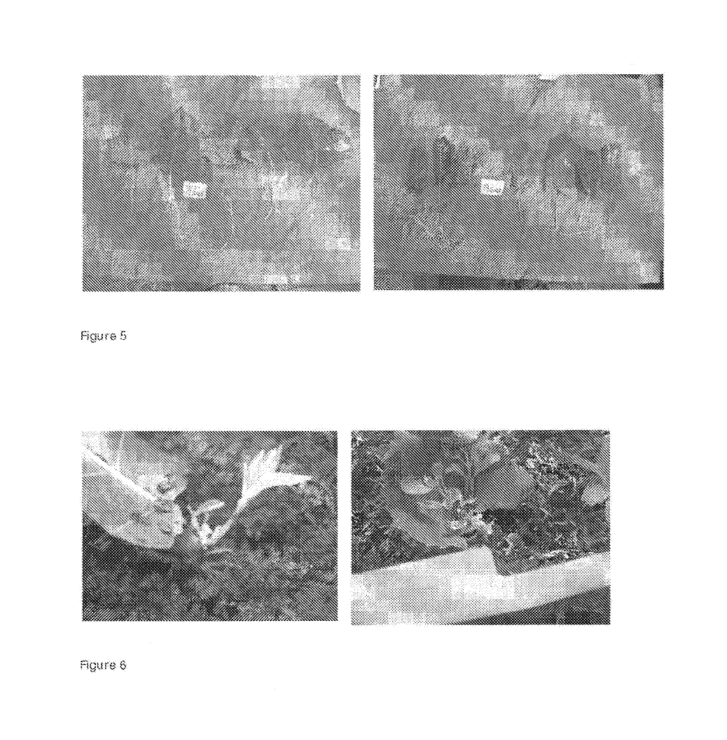

The general trend in all treatments was to favor the formation of roots first and then the formation of shoots, according to Table 1. FIG. 4 shows the formation of shoots and the emission of roots from Populus sp. leaves.

The number of roots per leaf cutting varied between 1 and 3 roots and the average length of the main root at 60 days was 35 cm. There was no significant effect of the substrate on the efficiency of root or shoot formation. On the other hand, the form of preparation of the cutting does not seem to influence significantly the efficiency of the rooting of the leaf cuttings (FIG. 5).

Although there was no effect of the leaf cutting type on rooting, the roots formed from whole leaf cuttings showed a better behavior than the cuttings whose limbus was cut, in terms of root development and appearance.

The same effect was observed in the case of shoots, where the general tendency was that the whole leaves formed a larger number than the leaves that had been cut (FIG. 6).

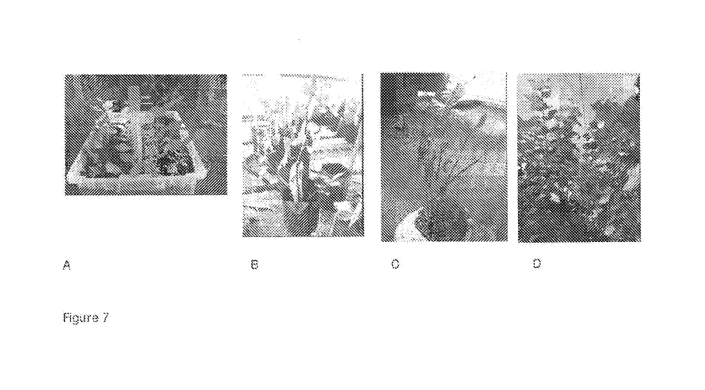

The plants generated by this technology continued their growth in a normal way. At 60 days they were transferred to a substrate for plant production. The plants were grown in shade so as to invigorate them. At 30 days, the plants were transferred directly to soil and at 9 months they had reached a height of 3.8 m. on average (FIG. 7).

### REFERENCES

Jaenicke, H., and Beniest, J. 2002. Vegetative Tree Propagation in Agroforestry, Training Guidelines and References. Unit 1: Introduction to vegetative tree propagation, pp. 1-15; Unit 3: Cuttings, pp. 55-71. International Centre for Research in Agroforestry, Nairobi, Kenya. ISBN 92 9059 1439.
Toenyan, N., Arnoldi, T., Mijares, M., Havili, S. 2015. Cutting Propagation Methods for PNW Native Shrubs and Trees.
Douglas, S. M. 2015. Basic Techniques for Propagating Plants.
Hartman, H. T., Kester, D. E., Davies, F. T., Geneve, R. L. 1997. Plant Propagation: Principles and Practices. Six Edition. Chapter 10 The Biology of Propagation by Cuttings, pp. 282-285, Chapter 11 Techniques of Propagation by cuttings, pp. 329-344. Prentice Hall International, New Jersey, USA. ISBN: 0-13-261488-X.

1. A method for vegetative propagation of poplar trees (Populus sp.), from prepared leaf cuttings, wherein in that the method comprises the following steps:
a) providing cuts of leaf cuttings from a donor tree,
b) immersing the prepared leaf cutting into a combination of growth regulators,
c) planting the prepared leaf cutting into a solid substrate of organic and/or inorganic origin,
d) inducing sprouting and rooting of the prepared leaf cutting, by means of controlled ambient temperature, humidity and illumination,
wherein steps a) through d) always occur outside an in vitro environment.

2. A method for vegetative propagation of poplar trees (Populus sp.), from prepared leaf cuttings, wherein in that the method comprises the following steps:
a) providing cuts of leaf cuttings from a donor tree, wherein the cuttings have a petiole of up to 10 cm in length,
b) immersing the prepared leaf cutting into a composition comprising at least one growth regulator, for a time period of less than or equal to 60 minutes, wherein said growth regulator is indole-butyric acid (IBA), or the cytokinins: 6-Benzylaminopurine (BAP, 6-BAP), 2-Isopentenyl adenine (2-iP) or a combination of said auxin and said cytokinins in a concentration equal to or less than 10 mgL⁻¹ of each,
c) planting the prepared leaf cutting in a solid substrate of organic and/or inorganic origin, wherein the substrate is selected from the group consisting of compost, humus, guano, ground leaves, peat, sand, sawdust, coconut fiber, perlite, vermiculite, and zeolite, applied independently or in mixtures of one or more substrates at different ratios.
d) inducing sprouting and rooting of the prepared leaf cutting, by means of controlled ambient temperature, humidity and illumination, wherein the temperature varies in minimum and maximum ranges from 4 to 40° C., ambient humidity of 40-100% at the height of the cutting, and brightness between 0 to 1000 μmolm²s⁻¹,
wherein steps a) through d) always occur outside an in vitro environment.

3. The method for vegetative propagation of poplar trees from prepared leaf cuttings according to claim 2, wherein in that the length of the petiole is between 0.5 and 10 cm.

4. The method for vegetative propagation of poplar trees from prepared leaf cuttings according to claim 2, wherein in that said combination of growth regulators is in the form of an aqueous solution or in the form of a powder comprising said regulators adsorbed onto a solid carrier.

5. The method for vegetative propagation of poplar trees from prepared leaf cuttings according to claim 2, wherein in that said combination of auxin and cytokinins is selected from the group consisting of IBA+BAP or IBA+2-iP.

6. The method for vegetative propagation of poplar trees from prepared leaf cuttings according to claim 5, wherein in that said growth regulator is in a solution having a concentration of 1.0, 1.5, 2.0, 2.5, 3.0, 3.5, 4.0, 5, 5.0, 5.5, 6.0, 6.5, 7, 7.5, 8, 8.5, 9, 9.5 or 10 mgL⁻¹.

7. The method for vegetative propagation of poplar trees from prepared leaf cuttings according to claim 5, wherein in that said growth regulator is in powder form having a concentration of 1, 1.5, 2, 2.5, 3, 3.5, 4, 4.5, 5, 5.5, 6.5, 7.5, 7.5, 8, 8.5, 9, 9.5 or 10 mg/g.

8. The method for vegetative propagation of poplar trees from prepared leaf cuttings according to claim 2, wherein in that the prepared cutting is immersed into the solution with growth regulators for a time period of 5, 6, 7, 8, 9, 10, 15, 20, 25, 30, 35, 40, 50 or 60 minutes.

9. A method for vegetative propagation of poplar trees (Populus sp.), wherein in that the method comprises the following steps:
a) providing cuts of leaf cuttings from a donor poplar tree, wherein the cuttings are prepared maintaining a petiole having a length of 3 to 10 cm,
b) immersing the prepared leaf cutting into an aqueous solution containing growth regulators, selected from the group consisting of IBA, BAP, 2-iP, IBA+BAP or IBA+2-iP in a range of concentrations of up to 5 mgL⁻¹ of each growth regulator, either simply added or mixed, wherein immersion into the aqueous solution occurs for 10 minutes.
c) planting the prepared leaf cutting into a solid substrate of organic and/or inorganic origin, wherein the substrate is selected from the group consisting of sand, sawdust, compost, applied independently or in mixtures of one or more substrates at different ratios,
d) inducing sprouting and rooting of the prepared leaf cutting, by means of controlled ambient temperature, humidity and illumination, wherein the temperature varies in minimum and maximum ranges from 21 to 29° C., ambient humidity of 65-85% and maximum brightness is 930 μmolm²s⁻¹,
wherein steps a) through d) always occur outside an in vitro environment.
